(19) United States
(12) Patent Application Publication
(10) Pub. No.: US 2006/0055934 A1
(43) Pub. Date: Mar. 16, 2006

(54) Method and apparatus for measuring amounts of non-cohesive particles in a mixture

(76) Inventors: Gregg Sunshine, Wilmington, DE (US); David Mark Scott, Wilmington, DE (US); Steven Irwin Gleich, Wilmington, DE (US)

Correspondence Address: Linda D Birch;E I Du Pont de Nemours and Company, Legal - Patents, 4417 Lancaster Pike, Wilmington, DE, 19898, US

(21) Appl. No.: 10/531,922

(22) PCT Filed: Nov. 20, 2003
(86) PCT No.: PCT/US03/37668

§ 371 Date: May 31, 2005

Related U.S. Application Data
(60) Provisional application No. 60/419,530, filed on Oct. 21, 2002.

(51) Int. Cl. G01N 21/47

(52) U.S. Cl. 356/446

(57) ABSTRACT

This invention relates to a method and apparatus for dynamically measuring relative amounts of particles having differing optical properties and/or shapes in a mixture, comprising an inclined path down which the particles travel, a feeder to present particles to the inclined path, a source of illumination to illuminate the particles on the inclined path, an image receiver to record reflective-light images of the particles and a composition calculator to determine the relative amounts of the particles based on the reflective-light images.

### FIELD OF THE INVENTION

The present invention relates to a method and apparatus that enable dynamic determination of the proportions of different types of non-cohesive particles in a sample of a mixture of the particles.

### BACKGROUND OF THE INVENTION

A variety of apparatus for measuring the size distribution and composition of granular materials are known. U.S. Pat. No. 6,061,130 for instance describes an apparatus for determining the particle size distribution and for characterizing the particle shapes in a particle mixture. The particles are metered and tumble vertically under the influence of gravity between a light source and an image-collecting device. A digital recording of the silhouette projection areas of the particles is used to analyze the particles. A similar device is described in U.S. Pat. No. 4,497,576, where a silhouette projection method is used. The device also includes use of parallel laser beams directed through a sample of falling particles and a means for recording the light passing through the sample. Digitized images of the silhouette images are used to analyze the particles according to criteria of surfaces, of square root of surfaces, of maximum widths, and of maximum heights. U.K. Patent Application GB 2012948A describes a falling assembly of particles which are subjected to a silhouette projection technique to measure particle size distribution of the particles.

PCT Patent Application Publication WO 89/05971 teaches how to generate a falling monolayer curtain of particles, which may then be lit by a conventional light source, and employs a silhouette projection as in U.S. Pat. No. 4,497,576, above. A recording unit for receiving the projected light allows collection of information about the silhouettes of the falling particles and may also be used to differentiate between various colors or gray shades of the particles. The means for generating the particle curtain in monolayer form consists of feeding the particles onto a conical vibrating plate with an angle of incidence from the horizontal such that the particle residence time on the plate is controlled.

European Patent Application Publication EP 1083007-A2 describes a detection device for removing substandard particles, particularly excessively colored grains of rice. The particles are illuminated as they free-fall off the end of an inclined plate and their color is measured. Particles having a measured color exceeding a threshold level are ejected using air nozzles.

According to a computer translation, Japanese Patent JP 98332567A describes a means for top-lighting a static sample of a mixture of particles of different types and using a digital camera to collect an image of the sample which may then be analyzed to determine the proportion of particle types differentiated, for example, by color.

Japanese Kokai Publication 08[1996]-89780 describes a granulating apparatus that can produce consistent quality particles by employing a means for continuously measuring the size of the particles and providing feedback to adjust water and powder ratios fed to the granulator. In the particle size measuring method the particles appear to be deflected from a falling vertical stream of particles onto an inclined plate which is illuminated by a light source. The reflected light is detected by a digital camera that captures information about the sample that is later converted into size and distribution information used to adjust control of the aforementioned granulator.

It is desirable to obtain information about non-cohesive particles in a mixture of different particles that not only describes their particle sizes and shapes, but additionally measures the fraction of each type of particle according to other observable characteristics, such as color or shade of gray, which can be indicative of chemical content. In the art cited above the investigators have collected data on particles using a variety of approaches, all of which have significant limitations for determining compositions.

The systems described in U.S. Pat. No. 6,061,130, GB 2012948A, U.S. Pat. No. 4,497,576 and WO 89/05971 collect projection or silhouette images of particles as they fall vertically. In this configuration the particles tumble as they fall, and the images collected are two-dimensional representations of three-dimensional particles presented in random orientation. Because of the random orientation, the shape and dimensional information that can be determined for individual particles is limited. Furthermore using projection or silhouette images makes discerning properties requiring top-lighting (such as color) difficult. Although WO 89/05971 urges ability to determine particle color or shades of gray by using a contrast plate, it does not describe how to operably configure the contrast plate with respect to the camera and light source shown on opposite sides of the curtain of falling particles, and its only example relating to color or shades of gray cites determining numbers of black and light particles, which have great difference in shade. EP 1083007-A2 provides a mechanism for identifying granules, in this case rice, which are defective and then for rejecting them. This publication expresses no intention and provides no mechanism for measuring the composition of the rice sample being upgraded.

In publication JP 98332567A, sample particles are held static and so can be presented to the camera with one dimension held in a constant orientation. When using such a system it becomes possible to identify the particles of one color or shade of gray versus others with different colors or shades of gray. The area of the particles of one type or another may also be determined, and a measurement of the proportion of one type of particle versus another can thereby be made. However, the static configuration of this system can have difficulty including enough particles without touching each other to enable imaging a representative sample. This limitation can lead to an impractical time requirement and a labor-intensive operation.

In publication JP 8[1996]-89780, particles produced in a granulating apparatus are directed onto an inclined plate. The plate is top-lit, and a digital camera records images of the particles as they descend. The angle of the plate is adjusted so that the particles move down it at an “appropriate speed”. The granular shape is not defined, but examples refer to spheres. The manner in which the particles are delivered to the plate is not defined. According to this publication, particle size and particle size distributions are determined. Without careful control for how the granules are introduced to the inclined plate it is not assured that they will remain aligned to the plane of the plate and without such control, only spherically shaped granules can be measured accurately. For instance, granules with elongated shapes will bounce and distort their top-view images making measurement of their true dimensions inaccurate. The method and apparatus disclosed in this publication are limited to determining particle size distributions of spheroidal particles and are not intended for determining distributions based on particle shape or optical property.

### SUMMARY OF THE INVENTION

The present invention relates to a method for determining the proportion of differing particle types in a mixture, comprising:
(i) feeding a mixture comprising at least two particle types of non-cohesive particles, each particle type having at least one optical property and/or shape differing from another particle type, to a path inclined at an angle sufficient to enable the particles to descend along the path;
(ii) illuminating the particles along the inclined path;
(iii) collecting reflective-light images of the illuminated particles; and
(iv) calculating the proportion of at least one particle type based on data from the reflective-light images indicative of the at least one differing optical property and/or shape.
   The at least one optical property, preferably, is at least one of reflectance, luminescence and variations thereof at visible, ultraviolet or infrared wavelengths. The inclined path, more particularly, is provided by a surface. Preferably, the proportion is based on at least one of number fraction, weight fraction and volume fraction.

A further aspect of the present invention is an apparatus for determining the proportion of particles of differing particle types in a mixture comprising:
(i) a particle feeder having an exit end;
(ii) an inclined path having an upper inlet end located adjacent to and below the exit end of the feeder to enable descent of non-cohesive particles down the inclined path;
(iii) a source of illumination oriented with respect to the inclined path so as to enable top-illumination of the particles as they descend down the inclined path;
(iv) an image receiver oriented with respect to the inclined path so as to enable collection of reflective-light images of the particles as they descend down the inclined path; and
(v) a composition calculator which converts reflective-light image signals received from the image receiver into data indicative of at least one proportion of particle types in the mixture based on at least one optical property and/or shape of the particles.

### BRIEF DESCRIPTION OF THE DRAWINGS

The present invention can be more fully understood upon having reference to the accompanying drawings described as follows.

FIG. 1 shows an overview of one embodiment of an apparatus of the present invention and its main components.

FIG. 2 shows an example image which could be taken by the video camera of FIG. 1.

FIGS. 3A and 3B illustrate the relationship between the inclined surface and the feeder and the “particle bounce” effect.

FIG. 4 illustrates a method for determining the optical properties of a particle from image information.

FIG. 5 shows a method for calculating area and the minimum distance for a particle cross-section from image information and illustrates how a systematic error can occur in area and width measurement.

FIGS. 6A, 6B, 6C, 6D, 6E, 6F and 6G illustrate some typical particle shapes suitable for the method and apparatus of the present invention.

FIG. 7 relates to Example 6 and shows an embodiment of the present apparatus modified to use ultraviolet light illumination.

FIG. 8 relates to Example 8 and shows a chart clustering particle image data into ellipsoidal and cylindrical sets.

### DETAILED DESCRIPTION OF THE INVENTION

As used throughout this disclosure, the following terms shall have the specified definitions:

“particle” means a relatively small discrete portion or amount of solid material and, more particularly, a relatively small solid object.

“particle type” means a class of particles sharing a common optical property and/or shape which allows them to be distinguished from other classes of particles having differing optical properties and/or shapes. Mixtures of particles can comprise more than one particle type. Non-limiting examples of mixtures comprising more than one particle type include: a mixture of red and green particles, in which the red and green particles each constitute distinguishable particle types; a mixture of cylindrical and spherical particles, in which the cylindrical and spherical particles each constitute distinguishable particle types; a mixture of broken and unbroken seeds, in which the broken and unbroken seeds each constitute distinguishable particle types.

“non-cohesive” means a property of particles indicating they exhibit a negligible tendency to restrict their movement through sticking or adhering to each other.

“particle-type standard” refers to specified optical properties and/or shape indicative of a particular particle type and which differentiate this particular particle type from other particle types. Particle-type standards can be based on dimensional relationships and/or other characteristics indicating shape and/or optical properties such as color, distribution of color, etc. For example, a standard for a white particle type differentiating it from a dark particle type could be based on a grayscale threshold, above which particles are classified as being of the white particle type. A color standard for a yellow particle type could specify red, green and blue intensities. Particles can be assigned to a particle type based on whether their optical properties and/or shapes fall within a deviation allowed (i.e. tolerance) from the particle-type standard, or meet or exceed a threshold specified for the particle-type standard. Alternatively, particles can be assigned to particle types based on determining which particle-type standard is the closest in optical property and/or shape.

“particle-type composition” is a composition comprising particles of at least two particle types. The description of such particle-type compositions according to the method and apparatus of the present invention includes reference to at least one proportion such as number fraction or a related fraction such as volume fraction or weight fraction, the fraction involving relative amounts of at least two particle types.

“number fraction” means the proportion of particles belonging to one particle type compared to the total number of particles belonging to that particle type and at least one other particle type in a composition of particles of at least two particle types. Number fraction can be calculated by dividing the sum of number of particles of the one particle type by the sum of the number of particles of that particle type and at least one other particle type. Number fraction can also be used to derive volume fractions provided that individual particle volumes (or dimensions from which particle volumes can be calculated) have been determined. Weight fraction can also be derived from number fraction provided that individual particles weights (or volumes from which particle weights can be calculated by multiplying by envelope density) have been determined. “number percentage” is number fraction multiplied by 100%.

“volume fraction” is calculated by dividing the sum of the volumes of particles of one particle type by the sum of the volumes of particles of that particle type and at least one other particle type in a composition of particles of at least two particle types. “volume percentage” is volume fraction multiplied by 100%.

“weight fraction” means the proportion by weight of particles of one particle type relative to the weight of particles of that particle type and at least one other particle type in a composition of particles of at least two particles types. Weight fraction can be calculated by determining the weights of individual particles from their volumes and envelope densities and then dividing the sum of the weights of particles of one particle type by the sum of the weights of particles of that particle type and at least one other particle type. “weight percentage” is weight fraction multiplied by 100%.

“envelope density” means the ratio of weight to volume for an individual particle and is substantially uniform within each particle type.

“bulk density” means the ratio of weight to volume for a bulk sample made up of many particles. The volume of a bulk sample includes not only the volumes of the individual particles but also the volumes of the space between particles.

“bounce angle” refers to the angle of deviation of the vector passing through the particle's longest dimension from where the vector would have been if the particle had been in equilibrium (i.e. at rest) on the inclined path or surface described for the method and apparatus of the present invention. More particularly, bounce angle is the angle of deviation component normal to the inclined path or surface (i.e. away or towards the inclined path or surface) and does not include the angle of deviation component parallel to the path or surface.

“luminescence” means the radiation of light at one or more electromagnetic frequencies resulting from illumination with light at other electromagnetic frequencies; luminescence includes, for example, fluorescence and phosphorescence.

“reflectance” means the ratio of amount of light at a particular electromagnetic frequency or range of frequencies reflected by a surface in relation to the amount of light at the frequency or frequencies incident on the surface.

“reflective-light image” means an image of an object illuminated from the same general direction as the object is imaged. Most commonly, reflective light comes from reflection of light in the same general spectral region as the illumination. However, reflective light also can include light from fluorescence and phosphorescence. For example, ultraviolet light illumination of an object having a fluorescent or phosphorescent surface results in emission of visible light that can be collected to form a reflective-light image.

“grayscale” means a numeric (typically integer) scale specifying the relative amount of light collected on a pixel in a digitized image from a video camera. Using the grayscale, a numeric value can be assigned to each pixel of the digitized image, the value relating to the amount of reflective light from the portion of the imaged object captured by the pixel. If essentially no light is collected on a pixel (such as from imaging a non-reflecting black background) the grayscale level is typically assigned a value of 0. Light at or above a certain high level collected on a pixel (such as from imaging a bright white object) is typically assigned the high end value of the grayscale, which for a 16-bit binary grayscale is 255.

“shape” means a distinguishable three dimensional form which may be described through geometrically based or empirically determined relationships among its defining dimensions. The simplest of the geometrically based shapes is the sphere, which may be completely described by specifying only its diameter. All projected views of a sphere show the diameter. A cylinder with a circular cross-section may be described by specifying its length and diameter. The length and diameter of a cylinder can generally be determined from length and width of its rectangular top-view image by inferring that if the cylinder is lying on its side, the length (longest dimension) of the rectangular image corresponds to the cylinder's length and the width (shortest dimension) of the rectangular image corresponds to the cylinder's diameter. With this information, the cylinder's volume can be calculated. Other regular shapes include the ellipsoid (shaped similar to an Australian or American football), which can be described on basis of its longest and shortest dimensions. This information is also available from its top-view projection. Irregularly shaped particles may require a variety of empirical information be collected prior to analysis in order to differentiate the particles by shape. But with sufficient shape differences, for example flake-shaped particles versus bead-like objects (e.g., cornflakes vs. raisins), distinguishing particles of different shapes is not difficult. Examples of different shapes include spheres, cylinders, ellipsoids, cubes, rhomboids, discs, flakes, corn seed shape, etc. A particular shape may vary in dimensions. For instance, cylinders may differ from each other in that they have different diameters and/or lengths. Cylinders of different sizes may share proportionality and have the same ratios of length to width, or the cylinders may also differ in that their length-to-width ratios are different.

“spheroidal” means a rounded shape resembling a sphere. Planar cross-sections through spheroidal shapes are all substantially circular. Three perpendicular axes through the center of a spheroidal shape have about the same length.

“ellipsoidal” means a rounded shape differing from a sphere in that some planar cross-sections are elliptical (i.e. oval) instead of circular, and the ellipsoidal shape can be described in terms of three perpendicular axes through the center of the ellipsoid, at least one axis of which is substantially not equal to the other axes (and thus in combination with another axis defines a non-circular ellipse).

The particulars shown herein are by way of example and for purposes of illustrative discussion of the embodiments of the present invention only and are presented to provide what is believed to be the most useful and readily understood description of the principles and conceptual aspects of the present invention. In this regard, no attempt is made to show structural details of the present invention in more detail than is necessary for the fundamental understanding of the present invention, the description making apparent to those skilled in the art how the several forms of the present invention may be embodied in practice.

Methods and apparatus in accordance with the present invention facilitate highly accurate particle analysis. Use of such apparatus and methods permit one to distinguish particles in a sample of particles, having differing optical properties and/or shapes, based on a number of optical and/or dimensional properties. By way of non-limiting examples, such optical and/or dimensional properties could include color, color variation, damaged vs. non-damaged, shape, size, roughness and luminosity. The apparatus and methods of the present invention solve the problems encountered with prior devices described above in the Background section of this specification.

The methods and apparatus of the present invention are useful for calculating the proportion of differing particle types within particle mixtures comprising at least two particle types of non-cohesive particles distinguished on the basis of differing optical properties and/or shapes. Not only can methods and apparatus of the present invention be used to determine the proportions of particle types within a particle-type composition, but the methods and apparatus can also determine dimensions such as longest dimension, shortest dimension and perimeter, and calculate derived dimensional properties such as area from top-view reflective-light images of the particles. Methods in accordance with the present invention are particularly useful when at least one dimensional property of the particles is also calculated using the reflective-light images in addition to determining a proportion of at least one particle type within the particle-type composition. Preferably, the at least one dimensional property is at least one of longest dimension, shortest dimension, area and perimeter. If the thickness is known or can be inferred from the top view, then particle volumes and volume fractions can be calculated. (Volume fractions can also be calculated if particle volumes are otherwise known.) If envelope density is also known, particle weights and weight fractions can be calculated as well. (Weight fractions can also be calculated if particle weights are otherwise known.)

The methods and apparatus of the present invention can be used with a wide variety of particles that are non-cohesive. Electrostatic interactions can cause very small particles to stick together, an effect that also becomes more significant with particles having low density. Therefore the methods and apparatus of the present invention are typically used with particles having surfaces capable of containing an inscribed sphere of at least about 0.1 mm diameter, more preferably at least about 0.5 mm diameter, and most preferably at least about 1 mm. Although the methods and apparatus of the present invention are most conveniently used with particles having a longest dimension not exceeding about 5 cm, larger particles can be used with appropriate scale-up of apparatus components, including the inclined surface. Examples of particles useful with the present invention include, but are not limited to, granules, chips, pebbles, candies, jewels, beads, metal shot, bullets, coins, seeds, processed foods, minerals, pills, etc. In a preferred embodiment, the methods and apparatus of the present invention are used with a mixture of non-cohesive particles comprising particles substantially cylindrical in shape. In a more preferred embodiment, the methods and apparatus of the present invention are used with a mixture of non-cohesive particles comprising particles having a shape substantially cylindrical with a circular cross-section.

Preferably, the method and apparatus of the present invention are used with particle mixtures comprising seed and/or particles comprising at least one agriculturally active material. Agriculturally active material is understood to mean any kind of biologically active material used in agriculture. Agriculturally active materials include, for example, crop protection agents (e.g., herbicides, fungicides, bactericides, invertebrate pest control agents), plant growth regulants (e.g., flowering or fruiting stimulating or suppressing, yield enhancing, or abscission agents, growth and re-growth inhibitors), foliage desiccants, chemical hybridization agents (e.g., pollen inhibition or sterilizing agents), and plant nutrition agents (e.g., fertilizers). In a preferred embodiment, the methods and apparatus of the present invention are used with mixtures of non-cohesive particles comprising particles comprising at least one crop protection agent. Crop protection agents are most commonly chemicals but also can be biological agents such as Bacillus thuringiensis and entomopathogenic bacteria, virus and fungi. Mixtures of non-cohesive particles comprising agriculturally active materials can also comprise non-cohesive particles which do not contain agriculturally active materials but which instead contain, for example, other useful components such as surfactants. In a preferred embodiment, the methods and apparatus of the present invention can be used with a mixture of non-cohesive particles comprising particles comprising at least one agriculturally active material and having a shape substantially cylindrical in shape, typically also substantially circular in cross-section. Substantially cylindrical non-cohesive particles comprising at least one agriculturally active material can be prepared by compaction or, more commonly, by extrusion (providing extruded granules), for example, of a moistened powder (e.g., paste-extruded granules) or heated composition comprising a heat-activated binder (e.g., heat-extruded granules).

Agriculturally active material can also have non-agronomic uses. For example, invertebrate pest control agents can be useful in other horticultural applications (e.g. forest, greenhouse, nursery or ornamental plants not grown in a field), public (human) and animal health, domestic and commercial structures, household and stored product applications.

In practicing methods in accordance with the present invention, non-cohesive particles are fed to an inclined path, typically provided by an inclined surface, down which the particles descend, substantially by rolling and/or sliding, under the influence of gravity. The particles thus generally remain in contact with the surface as they descend down it, and the longest axes of nonspheroidal particles will tend to be aligned parallel to the surface. The particles are illuminated as they descend down the inclined path. This configuration enables a video camera or the like, preferably aimed perpendicular to the inclined path, to record using reflective light individual top-view images of the particles. Analysis of the images allows for distinguishing optical properties and/or shapes and for determining such dimensional properties as longest dimension, shortest dimension, area and perimeter. If other parameters are available, particle volumes, volume fractions, particle weights and weight fractions can be calculated.

To facilitate image analysis, preferably the particles are fed in such a way that particle touching (e.g. one particle touching another particle) is minimal as they descend along the inclined path and also that they remain substantially in the plane of the path. Preferably less than 25% of the particles on the inclined path are touching another particle in the reflective-light images, and more preferably, less than 10%, most preferably, less than 2% of the particles are touching another particle in the reflective-light images. To minimize particle touching while maximizing throughput, preferably the particles are fed so that they are deposited uniformly along the inlet end of an inclined surface providing the path.

The feeding according to the present invention can comprise disposing the particles near an exit end of a feeder from which the particles are fed to the inclined path, the inclined path comprising an inlet end located adjacent to and below the feeding exit end. To accommodate the feeding motion, typically a gap is defined between the feeding exit end and the inlet end of the inclined path. To dispose the particles substantially in the plane of the surface and minimize bounce angle of non-spheroidal particles, the gap is preferably equal to or less than the shortest dimension of the particles to be measured. Dimensional measurement of top view images of non-spheroidal particles are more accurate when the bounce angle of particles is 10 degrees or less. Applicants have discovered that in aspects of the present invention in which the particles are non-spheroidal, a gap between feeding exit end and inclined path inlet end of equal or less than the shortest dimension of the particles results in at least 80% of the particles on the inclined path to have a bounce angle of 10 degrees or less. Narrowing the gap can decrease the percentage of particles having a bounce angle of 10 degrees or less. Preferably, at least 90%, more preferably at least 95% of the particles have a bounce angle of 10 degrees or less.

The particles are fed to the inclined path by a particle feeder. A wide variety of feeder designs are suitable for the methods and apparatus of the present invention. The particles can be fed using vibration or mechanically conveyed such as on a conveyor belt. In one embodiment a hopper supplies the feeder with a sample of a physical mixture of two or more particle types. The sample in the hopper contains enough particles to comprise a representative sample of the mixture to be measured. It is also within the scope of the present invention if the hopper and feeder are a single integrated unit. Preferably the feeder is a horizontal vibrating feeder with its leading edge positioned at a distance no higher than the shortest dimension of the particles being analyzed above the top of the inclined surface which it supplies and preferably closer without touching the upper edge of the inclined surface. Preferably, the edge of the feeder is conformed parallel to the inclined surface, and its center is positioned above the center of the inclined surface. The width of the exit end of the feeder can be equal to, or smaller than, the width of the inclined surface.

The particle feed rate can be set by the design of the particle feeder and/or adjustments of the configuration of components in the particle feeder. Alternatively, the particle feed rate and particle feeder can be controlled by a feed controller, which can, for example, change the frequency of vibration of a horizontal vibrating feeder or the speed of a conveyor belt-containing feeder. The feed controller can be set manually or based on feedback from the composition calculator or associated computational systems.

The inclined surface need only be sufficiently inclined to cause particles to descend down it under the influence of gravity such as by rolling or sliding. The minimum incline angle (relative to horizontal) sufficient to impart motion to the particles depends upon such factors as particle size, density and coefficient of friction with the surface. Vibration of the inclined surface can reduce the minimum incline angle to very low values; vibrating inclined surfaces are within the scope of the present invention, but excessive vibration may result in excessive bouncing which can cause artificial elongation or shortening of particle images, and in the typical method and apparatus of the present invention the inclined surface does not vibrate significantly. Only a small amount of experimentation is needed to determine the minimum incline angle for a particular inclined surface and particle mixture. As steeper incline angles promote more rapid particle travel and hence throughput, preferably the angle of incline is significantly greater than the minimum incline angle. Typically the angle of incline is at least 30° from the horizontal. However, the more rapid particle travel caused by increase in incline angle causes separation of particles, which can cause too few particles to be in each image if the feeder cannot compensate. Furthermore too steep an incline can promote particle tumbling and hence bounce angles in excess of 10 degrees. Therefore the inclined surface is preferably about 60° or less from horizontal. Typically an inclined surface about 45° from horizontal works well for the methods and apparatus of the present invention.

The inclined surface may be planar, convex, or have one of several “V”-like sections that direct the particles in parallel paths. By “convex” is meant a slightly curved surface that slopes downward towards each side from the centerline, the purpose of which is to increase the separation of the particles from each other as they descend the inclined path. A planar surface is preferred because of its simplicity of design and because it allows a relatively constant focal distance from the image receiver (e.g., camera).

The inclined surface is, preferably, coated or painted to be moderately non-reflecting and is prepared to provide a contrast that enables accurate top-view images of the particles to be recorded. For example, a surface comprising smooth non-reflecting glass coated on the underside with flat black paint works well with visible light, a black and white camera, and particles from off-white to medium brown in darkness. This construction provides a smooth surface of glass over which the particles descend and a dark background affording good contrast for image analysis. The particular coefficient of friction between the inclined surface and the particles is not critical so long as the surface is sufficiently smooth to allow the particles to descend without slowing.

Preferably the inclined surface is easily blown free of accumulated dust. In one embodiment of the present invention particularly preferred if the non-cohesive particles contain even small amounts of dust (e.g., 0.2% by weight), a stream of inert gas is blown nearly parallel but slightly downward towards the inclined surface to keep it free of dust particles that might accumulate. Such accumulations can create images that do not represent actual particles or form static fragments that could be counted more than once. By “inert gas” is meant any gas that does not react with the particles or apparatus of the present invention. Typically the inert gas is air. The gas flow is not necessary for particle conveyance, and the gas flow speed and angle at which the gas flow is aimed at the plane should not be so great as to cause turbulence or bouncing of particles. The flow of gas can be continuous or periodic according to convenience or need. The gas flow can be provided by one or more nozzles aimed to blow the gas stream nearly parallel but slightly downward towards the inclined surface. The gas stream can be supplied most simply by a single nozzle with a slit-shaped orifice disposed parallel to the inclined surface and having a width similar to the width of the inclined surface.

The terminal velocity of the particles on the inclined surface is the velocity above which the particles will naturally slow (to terminal velocity) as they travel down the inclined surface. Terminal velocity will depend upon the incline angle as well as particle size and density and coefficient of friction between particles and the inclined surface. To prevent particles from bunching together due to slowing on the inclined surface, the velocity of the particles from the feeder should be less than the terminal velocity of the particles down the inclined surface. Typically the velocity of particles from the feeder is much less than the terminal velocity, and the particles accelerate as they travel down the inclined surface but may not reach terminal velocity on the relatively short surface lengths typically used in the methods and apparatus of this invention. The feed rate of the particles to the inclined surface can be adjusted to minimize the particles touching each other as they travel down the surface.

The particles leaving the bottom edge of the inclined surface can be handled according to need and preference. Typically the particles are collected in a catch tray for disposal or recycling. If the number of particles imaged and analyzed from a first pass of particles from the feeder is not sufficient for a representative sample, the collected particles can be transferred back to the feeder for further pass through the apparatus.

The apparatus of the present invention can also be connected to the output of a mixing system to enable concurrently determining the proportion of differing particle types in the output mixture. Representative samples of the output mixture can be withdrawn either periodically or continuously and fed to the present apparatus. The analyzed particles can then be returned to the output stream of the mixing system. The proportion of differing particle types in the output mixture determined by the method of the present invention can then be recorded and displayed as a running average or for timed segments to indicate any variations in mixture composition over time.

The particles are sufficiently illuminated as they descend down the inclined path to allow collecting reflective-light images of the top-view of the particles. Typically the illumination is with visible light, which is ordinarily provided by one or more artificial light sources, although sunlight can also be used. Infrared and ultraviolet light sources can also be used if the image receiver (e.g., comprising a camera) is sensitive to the respective electromagnetic wavelengths. Also, an ultraviolet light source can be used with an image receiver sensitive to visible light if the particles being imaged are fluorescent or phosphorescent (causing ultraviolet light to be converted into visible light). Suitable light sources can be, for example, electric incandescent lamps (e.g., tungsten filament in nitrogen and/or argon; tungsten filament in halogen: quartz-halogen lamps, tungsten-halogen lamps), electric discharge lamps (e.g., fluorescent lamps, mercury-vapor lamps, sodium-vapor lamps, metal-halide lamps, carbon-arc lamps, xenon flash tube), semiconductor (e.g., light-emitting diode), and flame-heated (e.g., Welsbach mantle and limelight). Because of their simplicity, electric incandescent lamps are preferred sources of visible light. Mercury-vapor lamps and fluorescent lamps having ultraviolet wavelength emitting phosphors are preferred sources of ultraviolet light.

The one or more light sources need to be positioned to sufficiently illuminate the portion of particles from which top-view images are collected. Particularly if a light source provides illumination that is narrow rather than diffusely spread out over a broad area the light source is preferably located near the image receiver and aimed in about the same direction that the image receiver is aimed. Typically the illumination provided by the one or more light sources is continuous, but with certain lamp designs (e.g., xenon flash tube) the illumination is provided only when the image receiver is receiving an image.

Top-view images of the particles are collected using reflective-light captured by an image receiver aimed towards the inclined path. Preferably the reflective-light images of the particles are collected at about perpendicular to the inclined path, which entails aiming the image receiver about perpendicular to the inclined path. The image receiver comprises a camera with a lens system to focus the image on photosensitive element, which may be, for example, an orthicon or Vidicon tube or a charge-coupled device (CCD). A monochrome camera (i.e. “black and white”, capable of recording only total light levels) can be sufficient, or if the particle types are to be distinguished according to optical properties involving differing colors, a color camera can be used. In a preferred embodiment of apparatus of the present invention, the image receiver is a color image receiver and comprises a color camera.

Although most mixtures of particle types can be analyzed using a single monochrome or color camera, the present invention is not limited to use of a single camera. As an example, it can be advantageous to use two cameras, which are preferably synchronized. For instance, if one particle type is such that it reflects strongly in the infrared region of the spectrum, then one camera sensitive in that region can be used to provide images to identify which particles reflect strongly in the infrared. A visible-light camera can then be synchronized with the first to collect images used for identifying particles not strongly reflecting in the infrared. Both cameras can also be used to collect dimensional information.

The camera can produce an analog signal or digital representation of the image. If the camera produces an analog signal, a signal processing component in the image receiver, the unit for calculating compositions or another unit converts the signal to a digital representation of the image, referred to herein as a digitized image. Such digitization technology is commonplace in the art. By digitized image is meant that the image is represented as a matrix of picture elements (i.e. pixels) and to each is assigned a grayscale value if the image is black and white (i.e. monochrome). If the image is in color, each pixel is assigned several values according to one of several color image representation schemes (e.g., RGB system, which assigns intensity values for each of the red, green and blue components). The digitized images can then be processed by a composition calculator, wherein data collected from the digitized images is compared to a threshold value or other particle-type standard established for a particular particle type and at least one proportion describing particle-type composition based on a least one optical property and/or shape of the particles is thereby determined. The composition calculator typically comprises a digital processing unit and memory (e.g., a digital computer) and typically outputs composition data (e.g., reports) using one or more output devices of the kinds commonly used with computers (e.g., printers using inkjet, impact, heat- or light-sensitive paper, laser, toner, thermal wax transfer and/or dye sublimation technologies, light-emitting diode (IED) arrays, cathode ray tube displays (CRT), liquid crystal displays (LCD), projectors based on CRT, LCD or mirror (DMD, DLP) technologies). The composition data can also be output in electronic format to removable storage devices such as magnetic disk drives (e.g., floppy diskettes, Zip® disks) and optical disk drives (e.g., CD and DVD writers) for archiving or transport to other computers. The composition data can also be transmitted to other computers by way of a network based on, for example, conductive wire, optical fiber or radio frequency transmission.

The number of images per second processed by the system is typically selected according to the speed of travel of the particles and the field of view of the camera so that greater than 10% of the particles in the sample to be analyzed are imaged and preferably no particle is imaged twice before it exits the field of view of the camera.

Preferably the shutter speed of the camera is rapid enough to capture particle images artificially lengthened by their motion by no more than 1-2% relative to their true length in the direction of motion. For this invention, the particle speed is generated by the acceleration of gravity restrained mainly by forces of friction with the inclined surface and surrounding air. Image dimension lengthening occurs from the distance a particle moves between the shutter opening and closing. A typical shutter speed for commercially available cameras is 1/8000 second. By keeping particle movement rates below 100 mm/second, lengthening of any dimension greater than approximately 0.01 mm will not occur. Therefore, the image of a particle 3 mm in length in the direction of movement travelling down the inclined surface will not appear lengthened by more than 0.06 mm. If greater measurement accuracy is needed for a particular analysis, this may be achieved by using a camera with faster shutter speeds or by providing a means to slow particle speed, such as using more shallow surface angles from 15° to 300. Because image lengthening is predictable and systematic, it is also possible to correct image areas, widths, and lengths by building a correction factor into the software, which is well within the skill of the art.

Preferably the camera is positioned or a zoom lens on the camera is adjusted so the field of view captures the entire width of the inclined surface and thus all the particles in the sample pass through the field of view of the camera. Having all particles passing through the field of view helps ensure that a representative sample is imaged. Preferably the downwards length of the inclined surface is as least as long as the field of view of the camera. For sake of economy and convenience the downwards length of the inclined surface is typically not much greater than the field of view of the camera.

The camera, the light to be used, the manner of illumination, the light absorbing characteristics of the inclined surface and the software to analyze the data from the camera's images are selected according to particle characteristics so that particles of different particle types can be differentiated from one another. For instance, if the differences between particle types are based on differing shape or differing grayscale values, a simple black and white camera may be adequate. If color differences exist between the different particle types, then a color camera may be preferred or needed. If different degrees of reflectance of infrared or ultraviolet light is the basis for differentiation of particle types, then a light source and camera useful for the appropriate infrared or ultraviolet light electromagnetic frequencies are needed. If particle types having differing compositions (e.g., different crop protection active agents) do not otherwise possess shape, color or shade differences sufficient to distinguish them according to the method of the present invention, it may be possible to enhance the color or shade of one particle type as part of its production so that it can be distinguished. For example, extra pigment may be added to one particle type to enhance the color or gray level contrast differentiating it from other particle types. Inert agents such as titanium dioxide or carbon black may be added to the composition of a particle to lighten or darken its color, respectively. Another possible approach is making one particle type emit visible light when irradiated by ultraviolet light by adding a fluorescent ingredient to its composition. This approach requires excluding ambient visible light and is preferred only if simpler solutions cannot be used.

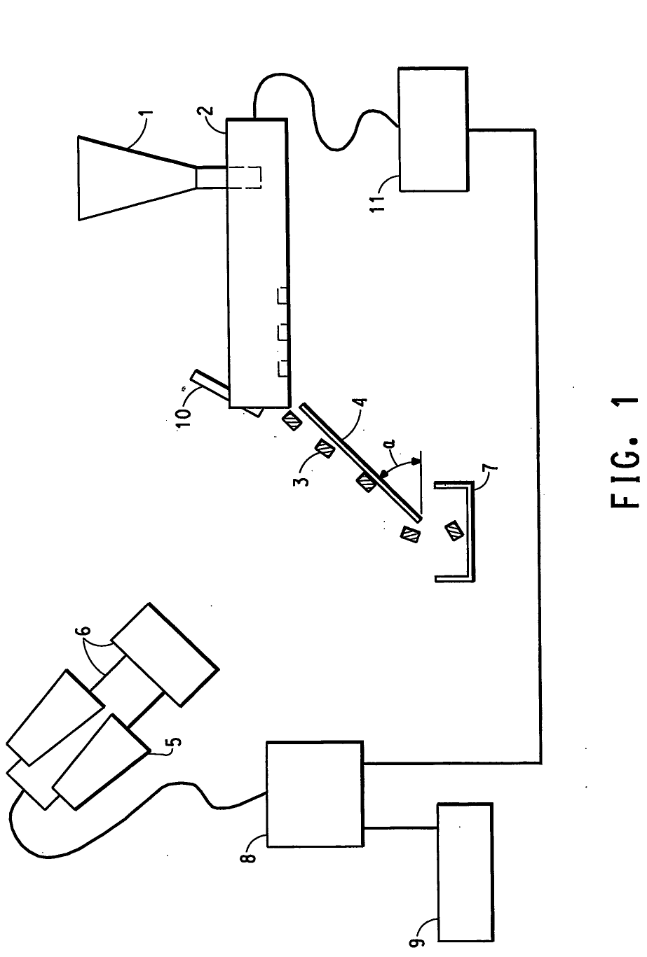

In one illustrative embodiment of the invention shown in FIG. 1, a particle mixture containing at least two particle types to be analyzed is placed into hopper 1. Particles 3 are fed from particle feeder 2 (depicted as a horizontal vibrating feeder) to inclined surface 4 inclined at angle α (depicted close to 45°) from horizontal. The particle feed rate is controlled using feed controller 11 in a manual mode or in a feedback mode based on feedback from composition calculator 8. The feed rate is controlled so that particles mostly do not touch each other as they descend down the surface and also so that the same particle is preferably not imaged twice in sequential images. As the particles descend down inclined surface 4, illumination source 5 (depicted as multiple units) illuminates the particles 3 while image receiver 6 (depicted as a video camera) captures images of the moving particles. The images are analyzed using composition calculator 8 (e.g., a digital computer), which outputs composition reports using output device 9. Output device 9 typically comprises at least one computer monitor. In this illustrative embodiment, particles 3 leaving inclined surface 4 are collected in catch tray 7, and nozzle 10 is used to blow a stream of inert gas to keep inclined surface 4 free of dust.

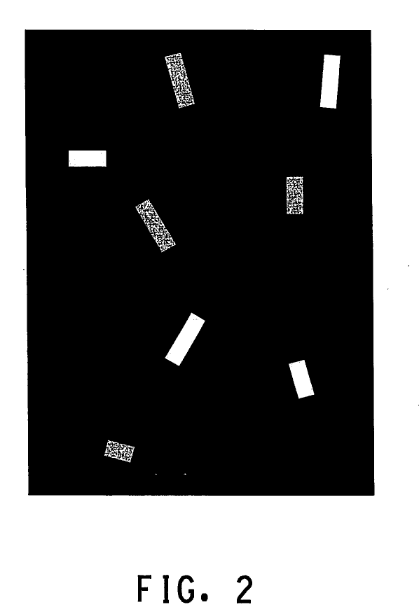

FIG. 2 illustrates a what a typical monochromatic camera image of cylindrical particles with two different grayscale values on a black-colored inclined surface would look like.

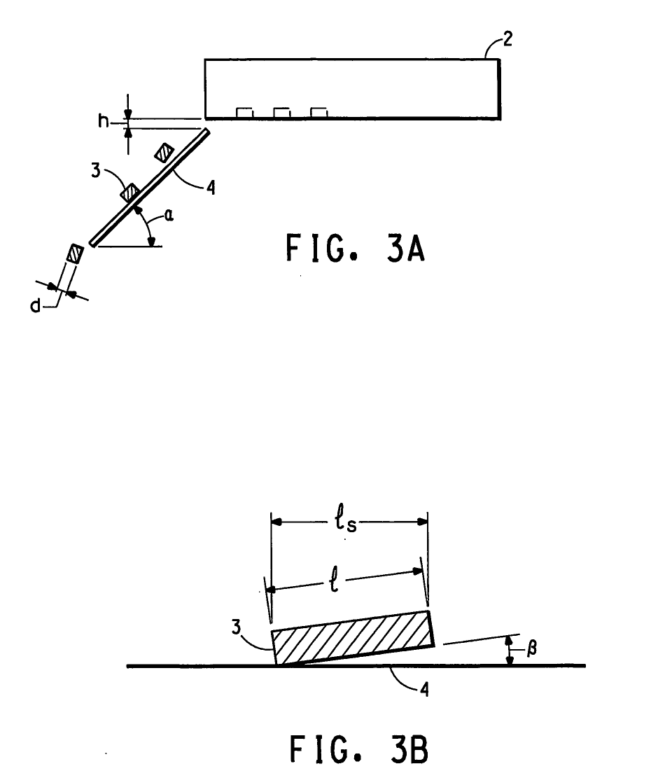

FIG. 3A and FIG. 3B depict the manner in which particle bouncing occurs. If the particles being measured are spheroidal, bouncing along the inclined surface is not a particular concern regarding accuracy of measurement. However, such is not the case for non-spheroidal particles, as substantial bounce along the inclined surface can substantially affect the accuracy of measurement. FIG. 3A shows an enlarged schematic of the relationship between particle feeder 2 and inclined surface 4 containing particles 3 of cylindrical shape with circular cross-section for which the shortest dimension is the diameter, d. The exit end of particle feeder 2 is positioned a distance h above the leading edge of inclined surface 4. Particles 3 tip slightly as they exit particle feeder 2 because of the distance the leading edge of each particle must descend before contacting inclined surface 4. This can cause some of particles 3 to bounce slightly.

FIG. 3B shows that if a particle is displaced from the plane by a bounce angle β in the direction of particle length l then corresponding image length l_{S} in the top-view image taken perpendicular to the inclined surface of the particle can be foreshortened. The relation of the ratio of image length l_{S} to particle length l as a function of bounce angle β is given by Formula 1.
l_{S}/I=cos(β) Formula 1
When bounce angle β does not exceed 10 degrees then image length l_{S} will be less than 2% less than particle length l, thereby providing greater than 98% accuracy in the top-view images.

Depending upon other particle dimensions (e.g., thickness) the bounce angle β can also cause the image length to be artificially lengthened due to the particle's side being upturned and included in the top-view image. As artificial image foreshortening and lengthening are both undesirable, bounce angle β is preferably minimized.

As depicted in FIG. 3A, bounce tends to be greatest immediately after release of particles 3 from particle feeder 2 to the top of inclined surface 4 and diminishes with subsequent movement down inclined surface 4. Preferably, at least 80% of the non-spheroidal particles on inclined surface 4 have a bounce angle of 10 degrees or less. More preferably, at least 90% of the non-spheroidal particles have a bounce angle of 10 degrees or less. Most preferably, at least 95% of the non-spheroidal particles have a bounce angle of 10 degrees or less. For spherically shaped particles, bounce angle is not an issue. Applicants have discovered that bounce angle β of particles 3 on inclined surface 4 will usually be less than 10 degrees when h is less than or equal to d.

The proportions of differing particle types within a particle-type composition are calculated using a composition calculator which analyzes digitized images of particles on the inclined surface. Based on analysis of the digitized images to distinguish, differing characteristics based on optical properties and/or shapes, the composition calculator identifies each analyzed particle as belonging to one of two or more particle types. Identification of a particular analyzed particle as belonging to one of two or more particle types can occur by comparing the data collected from the digitized image of the particle and comparing it to a threshold value or other particle-type standard established for a particular particle type. The number of particles assigned to each particle type can then be summed. The number fraction for a particular particle type is the sum of the particles having that particular type divided by the sum of particles of that particle type and at least one other particle type.

The computational methods needed to differentiate particle types based on optical properties and/or shapes will depend upon the particular optical and/or shape differences to be distinguished. While the methods can vary greatly, suitable methods will be obvious to the skilled artisan considering the particular characteristics to be distinguished. Implementing such methods in computer code is well within the ability of those skilled in the art.

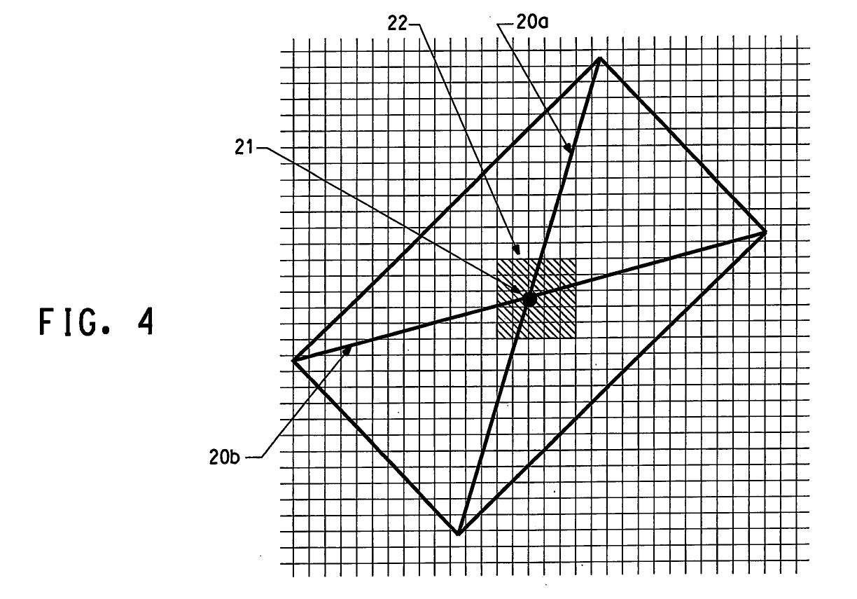

FIG. 4 illustrates an approach for identification of particle type based on optical characteristics of a digitized top-view image of a particle. Centroid 21 of the top view of the image is located at the intersection of rectangle diagonals 20a and 20b. Then image data for the 25 pixels in kernel 22 around centroid 21 are analyzed. For instance if grayscale is used to differentiate particles a “threshold” grayscale value is chosen, at or above which the light-colored particle pixel values fall, and below which the dark-colored particle pixel values fall. Each particle that is measured can then be identified and tagged either as a member of the dark-colored group or of the light-colored group. All of the particles in the data set are evaluated and assigned to one group or the other. If color is the differentiating optical characteristic, then average intensities of light at several wavelengths collected by the pixels in kernel 22 are determined and compared with standard color values to identify the most probable color of the particle. This is repeated for all images collected, and then each imaged particle is assigned to a particle type defined by color.

Differentiation of one type of particle from another can be made on the basis of a wide variety of optical properties, including reflectance and luminescence at visible, infrared (including near infrared) and ultraviolet regions of the electromagnetic spectrum, and variations thereof (including both by electromagnetic frequency and also spatially, e.g., stripes, banding, mottling, uniformity). In such cases analyzing a 25-pixel kernel around the centroid of the particle image may not be an appropriate computational approach. For striped particles, for instance, one may choose to examine sections along the particle image's length and in this way ascertain variations in grayscale or wavelength indicating a varying pattern. In the visible light region, differing optical properties typically involve light not being equally reflected at all frequencies, resulting in color (described, for example, in terms of hue and saturation) as well as different degrees of overall lightness. Light in the infrared and ultraviolet regions is also typically not equally reflected at all frequencies, and this variation too can be used for analysis. The particles of one particle type in a mixture can be formulated to include an agent (e.g., carbon black for darkening, titanium dioxide for lightening, phosphors for inducing fluorescence or phosphorescence) that accentuates optical property differences enabling these particles to be accurately identified during analysis.

Along with calculating the proportion of at least one particle type within a particle-type composition, dimensional properties of the top-view images such as longest dimension, shortest dimension, area and perimeter can be determined using a variety of calculation methodologies or algorithms, all well within ordinary skill in the art. For example, commercially available software such as LabVIEW IMAQ from National Instruments Corporation (Austin, Tex.) provides such information as the area and perimeter of digitized top-view two-dimensional images of particles.

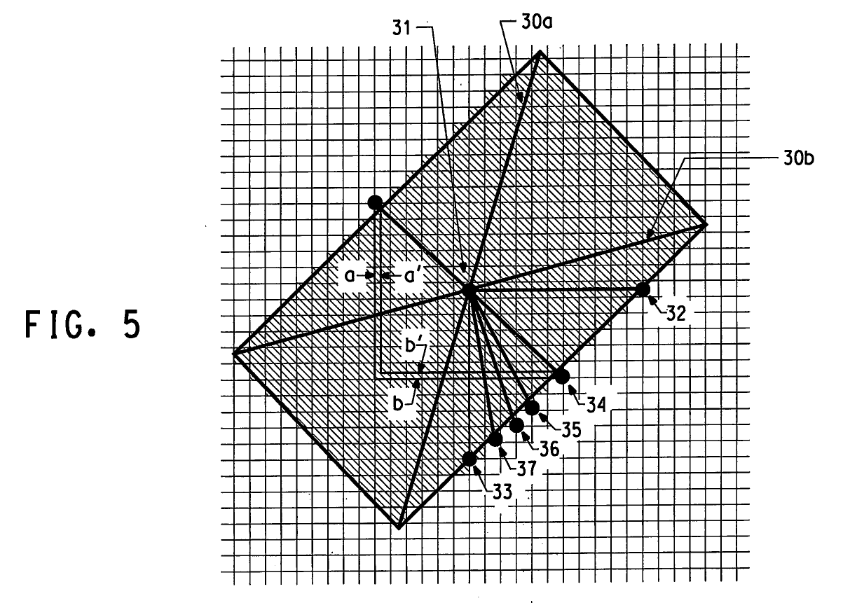

The top-view area of a particle can be easily computationally determined by first counting the pixels in its digitized image. FIG. 5 illustrates the digitized form of a representative particle image from FIG. 2, i.e. a rectangular top-view image shape such as from imaging a cylindrical particle. Next, the number of pixels in the digitized particle image is multiplied by the reciprocal of the square of the digitized image calibration factor (hereafter simply “calibration factor”) to give the top-view area in terms of a physical unit such as mm². The calibration factor relates digital measurements of the digitized particle image with actual particle dimensions and is expressed in terms of pixel widths in the digitized particle image corresponding to a physical unit distance (e.g., mm) on the imaged particle. The calibration factor can be determined by, for example, placing a thin, circular, matte, white-colored disc of known diameter on the inclined surface and dividing the number of pixel widths spanning the diameter of disc image by the actual disc diameter (e.g., in mm).

The determination of top-view particle area based on counting pixels is subject to systematic error. By “systematic error” is meant an error of regular and predictable magnitude for the particular configuration of system components and measurement approach used. Systematic error in area measurement is primarily caused by limitations in the resolution of the digitized image (resulting in a finite calibration factor) and the methodologies and algorithms defining the boundary or edge of the particle image in terms of pixels. The actual boundary of a particle image will often traverse the middle of a pixel. Counting a traversed pixel as part of the image will tend to slightly exaggerate the top-view area of the particle, while not counting a traversed pixel will understate the top-view area of the particle.

FIG. 5 depicts a particle image wherein the measurement method used counts? pixels traversed by the particle boundary as part of the particle image. In FIG. 5, each square represents a pixel. The shaded area shown in FIG. 5 represents the area determined by the measurement method, which in this case yields an area of 456 pixels. However, if pixels intersected by the particle image could be treated as fractions to give the true top-view area, the area would be found to correspond to only 405 square pixels. Thus the relative error is (456−405)/405=12.6%. Smaller particles will generally show larger positive relative errors, and larger particles will show smaller positive relative errors. The relative error decreases not only with increasing particle area but also with increasing calibration factor. Given the predictability of this systematic error, it is possible to adjust measured particle areas so they more accurately represent actual areas. Also, analysis of the amount and frequencies of light (e.g., grayscale, color depth) captured by each pixel may allow excluding pixels of which only a minor part is occupied by the particle image while counting pixels of which a major part is occupied by the particle image.

Another measurement that can be made using a digitized particle image is the shortest distance across the image (i.e. its width). There are a variety of ways, all within the skill of the art, to determine this distance, and each one of these has sources of error associated with it. For sake of illustration, a specific width determination method useful when the particle images are rectangular (e.g., from cylindrical particles) is discussed here. In FIG. 5, centroid 31 of the top view of the image is located at the intersection of rectangle diagonals 30a and 30b. Horizontal line 32 and vertical line 33 are drawn from centroid 31 to edge of digitized particle image pixels. Line 34 is drawn at a 45° angle between horizontal line 32 and vertical line 33. Then three additional lines 35, 36 and 37 are drawn between the two shortest of lines 32, 33 and 34 (lines 32 and 34 in this case). The shortest of lines 32 to 37 (line 34 in this case) then defines the location of the width, and this line is extended until it crosses from the digitized particle image pixels to the background pixels. The width is then designated as the distance between the two pixels at either end of the line where the digitized particle image transitions to background. After the width and area are calculated the length of the rectangular digitized particle image can be calculated by dividing the area by the width.

FIG. 5 also shows how error in the width measurement can occur. The accurate width measurement is the hypotenuse of the triangle with sides a′ and b′. What is actually measured is the hypotenuse of the triangle with sides a and b. As the lines are drawn in this particular method to the outer boundary of pixels which may only be partly occupied by the particle image, the relative error will be always positive. In some cases, as with lines 32 and 33 in FIG. 5, the true and measured values are the essentially the same. This occurs because the lines are drawn at 0° and 90°, which are both parallel with and in this case coincident with the pixel boundary grid lines. Another source of error in the width measurement arises because the none of lines 33, 34, 35, 36, and 37 may represent the shortest line that could be drawn from centroid 31 to the particle image transition to background. These systematic errors can be reduced by building corrections into the software using methods well within the skill of the art, although additional computer processing time or speed may be required. Also as for area calculation, error in width measurement may be reduced by analyzing the amount and frequencies of light (e.g. grayscale, color depth) captured by each pixel to allow excluding pixels of which only a minor part is occupied by the particle image while counting pixels of which a major part is occupied by the particle image.

If particle volumes of particle types are constant known values, then volume fractions can be calculated using the known particle volumes after determining the number of particles of each particle type. If particle volume is not a constant for a particle type, then calculation of volume fractions also requires determining the volume of each particle.

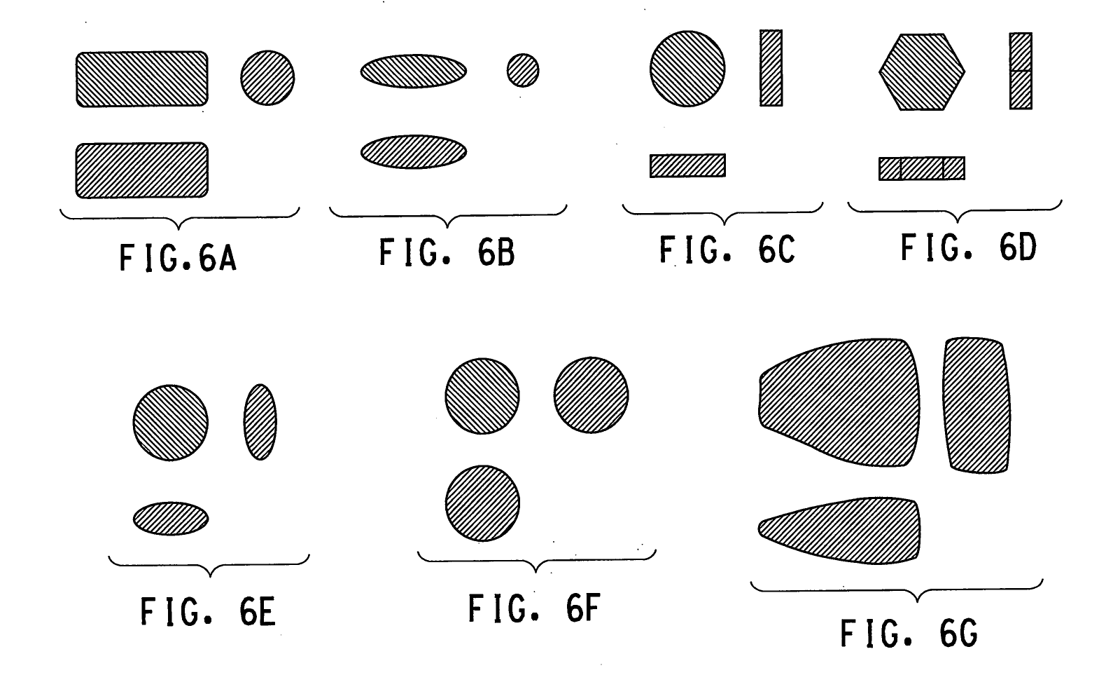

Depending on the availability of dimensional information (e.g., thickness) that cannot be directly measured but for some shapes can be inferred from top-view particle images, the volume of particles can be calculated. FIG. 6A through FIG. 6G illustrate a variety of particle shapes which can be evaluated using the method and process of this invention. FIG. 6A shows top-view 40, side-view 41 and front-view 42 of a cylindrical particle with typically rounded edges. FIG. 6B shows top-view 43, side-view 44 and front-view 45 of an ellipsoidal particle with two equal short axes and one longer axis. FIG. 6C shows top-view 46, side-view 47 and front-view 48 of a round disc particle. FIG. 6D shows top-view 49, side-view 50 and front-view 51 of a hexagonal disc particle. FIG. 6E shows top-view 52, side-view 53 and front-view 54 of a round oval particle. FIG. 6F shows top-view 55, side-view 56 and front-view 57 of a spheroidal particle. FIG. 6G shows top-view 58, side-view 59 and front-view 60 of a somewhat irregular particle which nevertheless has substantial symmetry through two mirror planes and one rotation axis (C₂, symmetry group).

Some of the shapes shown in FIGS. 6A through 6G are particularly important for applications of the methods and apparatus of the invention to agriculture and nutrition. Granules extruded through a circular die have a cylindrical shape as illustrated in FIG. 6A. Granules prepared using pan granulation and some agricultural crop seeds have an ellipsoidal shape as illustrated in FIG. 6B. Some nutritional supplement tablets have a round disc shape as illustrated in FIG. 6C. Some candies have a round oval shape as illustrated in FIG. 6E. Granules prepared using fluid bed granulation and some agricultural crop seeds such as soybeans have a spheroidal shape as illustrated in FIG. 6F. Maize seeds have the shape shown in FIG. 6G.

For the cylindrical shape shown in FIG. 6A, the ellipsoidal shape shown in FIG. 6B and spheroidal shape shown in FIG. 6F the unseen (thickness) dimension can be inferred to be the same as the width of the top-view particle image. The volumes can be calculated using standard mathematical formulae. For example, the volume V of the cylindrical shape in FIG. 6A is given by Formula 2:
V=(πd²l)/4 Formula 2
wherein d is the particle diameter (inferred from the width of the particle image) and l is the particle length (obtained from the length of the particle image). Specific formulae for calculating volumes for various shapes are well known in the art of geometry. More generally, if the cross-sectional area of a particle can be specified as a function f(x) wherein x specifies distance along an axis normal to the cross-sections, then the volume V can be obtained by analytical or numerical integration along the axis from one end of the particle to the other according to Formula 3.
V=∫f(x)dx Formula 3

For the shapes shown in FIG. 6C, FIG. 6D, FIG. 6E and FIG. 6G, the thickness cannot be inferred from the top-view particle image. But if the thickness of the shapes shown in FIG. 6C, FIG. 6D and FIG. 6E is otherwise known (such as if the thickness is uniform among particles) particle volumes can be easily calculated from the top-view images with relatively high accuracy. Shapes with geometric regularity such as cylinders, spheres, ellipsoids and discs, to name a few, allow the greatest dimensional accuracy measured with the methods and apparatus of this invention. As the shape regularity or predictability diminishes, then so does particle dimension measurement accuracy. Even for some somewhat irregular shapes such as the maize seed shown in FIG. 6G, shape regularity is consistent enough that some knowledge of the thickness dimensions can allow calculation of approximate volume. If thickness dimensional information is known or can be inferred from the top-view particle images, volumes can be calculated with greater or lesser precision for nearly all shape types. However, for many applications of the methods and apparatus of the present invention (e.g., determining the proportion of red candies in a mixture of candies with different colors, or determining the proportion of weed seeds compared to crop seeds) calculating number fractions based on counting particles of differing particle types may be the only calculation desired.

If particle weights of particle types are constant known values, then weight fractions can be calculated using the known particle weights after determining the number of particles of each particle type. If particle weight is not a constant for a particle type, then calculation of weight fractions also requires determining the weights of particles. Weights of particles can be determined by multiplying the envelope density of the particles by their volumes. The envelope density can be measured by submerging a measured weight of particles of a particular particle type in a liquid in which the particles are not soluble. The weight of particles divided by the volume of liquid displaced provides the envelope density.

Determining the overall weight percentages of chemical ingredients in a mixture of particle types having different amounts of the chemical ingredients may be desired. For example, products from the agrochemicals industry may comprise mixtures of particles of two or more particle types wherein each particle type contains different agriculturally active materials (i.e. active ingredients). If the active ingredients themselves do not provide sufficient optical property differences to allow readily distinguishing particle types, other ingredients can be added to provide distinguishable optical properties and/or the shapes of particles can be used as markers identifying particle types having differing chemical compositions, such as differing active ingredients. Normally, the percentages of ingredients (such as active ingredients) in a particle type is available before mixing, either from the amounts of ingredients used to prepare the particles or from chemical analysis of the prepared particles. With this information, the overall percentage of a particular ingredient in the mixture can be easily calculated.

Without further elaboration, it is believed that one skilled in the art using the preceding description can utilize the present invention to its fullest extent. The following Examples are, therefore, to be construed as merely illustrative, and not limiting of the disclosure in any way whatsoever. The various calculation options shown in the Examples below are presented for illustration only.

### EXAMPLE 1

### Illustrative Apparatus and its Operation

The Examples which follow utilize an apparatus and method of the present invention as described in this first Example. With reference to FIG. 1 as a schematic diagram, the apparatus consists of the following parts:

Hopper 1, which provides a supply of particles 3 to particle feeder 2, is a stainless steel funnel (Cole-Parmer Model SR-07265-00) approximately 5 inches (12.7 cm) in diameter at the top narrowing down to an opening no smaller than 0.5 inch (1.3 cm) at the bottom. Particle feeder 2 is a Syntron® (Model FL-TO-C) Light Capacity Electromagnetic Vibrating Feeder (FMC Corp.), which is supported parallel to the table or bench top (not shown) on which the apparatus rests. The funnel is positioned at the back end of a vibrating feeder and secured so that the funnel outlet is ⅜ to ⅝ inches (1.0 to 1.6 cm) above the feeder.

Inclined surface 4 is a piece of flat non-reflecting glass with dimensions 2.9 inches (7.4 cm) wide and 4.0 inches (10 cm) long. The underside of the glass is coated with flat black paint. The piece of glass is cushioned on a piece of ⅛-inch (0.3 cm) thick polyethylene foam sheet (not shown) with the same dimensions as the glass. The glass and foam are supported at an inclination angle α of 45° from horizontal. The front edge (i.e. exit end) of the particle feeder 2 is positioned no more than 1 mm above the top (i.e. upper inlet end) of inclined surface 4. Particle feeder 2 and the glass of inclined surface 4 do not touch. The feeder vibration frequency (and hence rate of feeding) is controlled with an FMC Power Controller (Model CC-1A) as feed controller 11.

Image receiver 6 is a video camera (Pulnix Black and white Progressive Scan Analog Model 9701), the zoom lens of which is positioned approximately 9 to 10 inches (23 to 25 cm) from and pointed perpendicularly to inclined surface 4. The zoom lens of the camera is the equivalent of a Cole-Parmer model #P-48901-04. The shutter speed of the camera is 1/8000 second, and the resolution of the camera is 640×480 pixels.

On either side of image receiver 6 are positioned two tungsten-halogen lamps equivalent to W·A·C Long Life 10,000 hour #EXN 50W MR16 floodlights (sold by W·A·C Lighting Co., 615 South Street, Garden City, N.Y. 11530) as illumination source 5. The lamps, powered by an Astec LPS 253, 12V DC, 20 amp Power Supply (not shown), are housed in W·A·C Lighting #LP007 Black Surface, low voltage mounts aimed to evenly illuminate inclined surface 4.

A stream of air from nozzle 10 is used to sweep inclined surface 4 free from dust. Nozzle 10 comprises a slit dimensioned 1.75 inches by 0.02 inches (4.44 cm by 0.05 cm) with the long dimension parallel to inclined surface 4. Nozzle 10 is positioned above the top of inclined surface 4 and at an angle of 50° down from horizontal so that the air stream gently sweeps inclined surface 4 at an oblique angle. The air supply to nozzle 10 is 5-10 psi (34.5-68.9 kPa), which is provided by an SMC NAR 2000-N01, 0-30 psi (0-207 kPa) pressure regulator (not shown) connected to 70 psig (483 kPa) air source (not shown).

An appropriately sized receptacle is used for catch tray 7, which collects the particles as they fall down the surface.

A computer with an Intel Pentium II 200-megahertz processor and Microsoft Windows 95 operating system is used as composition calculator 8. National Instrument's LabView IMAQ software is employed to process the camera images. In order to digitize the analog images a National Instrument's “Framegrabber” Board #1408 is installed in the computer. Software including Microsoft Excel is used to create reports comprising tables and/or graphs from data obtained from processing the camera images. Output device 9 comprises both a computer monitor and printer.

The system is calibrated as follows: A piece of white paper is placed flat against the glass plate, and the lights are adjusted so that the light is evenly distributed on the paper. Another piece of paper with a black circle of precisely known diameter, around 10 mm, is then placed on the piece of white paper, and after the camera is well focused the number of pixel sides per millimeter is determined to establish the calibration factor in units of pixels/mm to be used for the sample analysis to follow.

A particle sample of 20-40 g is placed in the funnel, the air supply is turned on to sweep the glass surface, and the camera zoom lens is adjusted to capture images in the field of view through which the particles will pass. The vibrating feeder is turned on and a feed rate established such that from 5-10 particles are captured per image. This corresponds to a feed rate of approximately 100-150 particles per second. Approximately 2-3 images per second are captured, and the analysis continues until all the particles placed in the funnel have passed through the field of view. The captured images are analyzed as described in examples which follow.

### EXAMPLE 2

### Analysis of Multiple Samples of a Particle Mixture

A mixture was prepared using Pinnacle® 25DF Herbicide paste-extruded particles (DuPont, 126.4 g) containing 25 wt % thifensulfuron-methyl as active ingredient and Authority® 75DF Herbicide paste-extruded particles (FMC Corporation, 126.3 g) containing 75 wt % sulfentrazone as active ingredient. Both particle types were cylindrically shaped with diameters approximately 1 mm and with lengths varying over an approximate range from 1 mm to 5 mm. Pinnacle® 25DF was light tan in color with a measured envelope density of 1.85 g/cm³. Authority® 75DF was medium brown in color with a measured envelope density of 1.43 g/cm³. The particles were tumbled together to produce a roughly homogeneous mixture (although homogeneity was not a particular goal of this experiment). The 252.7-g mixture was then separated into aliquots to provide 10 samples having weights varying from 17.31 to 27.60 g.

Each of the 10 samples was analyzed under visible light using the method of the present invention. The appearance of the top-view images on the black inclined surface was similar to that illustrated by FIG. 2. Using the approach described for FIG. 4 involving average grayscale values for a 25-pixel kernel surrounding the centroid of each particle and a threshold of 190 based on a 16-bit grayscale, particles were identified either as light (i.e. Pinnacle®) or dark (i.e. Authority®).

Particle image widths were determined with computer software using the method described for FIG. 5. Areas of top-view particle images were determined using LabView IMAQ software. Particle length was calculated by dividing particle image area by particle image width. As the particles were cylindrical, particle image width was considered to accurately represent particle diameter, and the volume of particles was calculated according to Formula 2. This allowed calculating volume percentages. Formula 4 shows the calculation of the volume percentage of light-colored particles VP^{L} in a mixture of n^{L} light-colored particles and n^{D} dark-colored particles, where ΣV^{L}ᵢ is the sum of volumes for the light-colored particles and ΣV^{D}ⱼ is the sum of volumes for the dark-colored particles.

$${VP}^{L} = 100 \% \cdot ( {\sum }_{i = 1}^{i = {n}^{L}} {V}_{i}^{L} ) / ( {\sum }_{i = 1}^{i = {n}^{L}} {V}_{i}^{L} + {\sum }_{j = 1}^{j = {n}^{D}} {V}_{j}^{D} ) \qquad Formula 4$$

The volume percentages of light-colored (i.e. Pinnacle®) and dark-colored particles (i.e. Authority®) were analyzed according to particle length. For example, Table 1 lists percentage volumes for particles in various length ranges from Sample 2, for which about 1690 light-colored and 3110 dark-colored particle images were analyzed.

TABLE 1
Percentage Volume of Particles in Various Length Fractions for Sample 2.

| | Volume % | |
|---|---|---|
| Length (mm) | Light-colored (Pinnacle ®) | Dark-colored (Authority ®) |
| 0.125-0.375 | 0 | 1.195 |
| 0.375-0.625 | 0 | 0.051 |
| 0.625-0.875 | 0.083 | 0 |
| 0.875-1.125 | 0.441 | 0.101 |
| 1.125-1.375 | 5.034 | 1.768 |
| 1.375-1.625 | 10.676 | 7.627 |
| 1.625-1.875 | 14.386 | 15.262 |
| 1.875-2.215 | 19.31 | 22.628 |
| 2.125-2.375 | 20.234 | 17.729 |
| 2.375-2.625 | 10.759 | 11.786 |
| 2.625-2.865 | 7.131 | 7.686 |
| 2.875-3.125 | 3.807 | 4.445 |
| 3.125-3.375 | 3.945 | 3.502 |
| 3.375-3.625 | 2.703 | 2.711 |
| 3.625-3.875 | 1.034 | 1.01 |
| 3.875-4.125 | 0.221 | 0.539 |
| 4.125-4.375 | 0.234 | 0.716 |
| 4.375-4.625 | 0 | 0.758 |
| 4.625-4.875 | 0 | 0.32 |
| 4.875-5.125 | 0 | 0.168 |

Table 1 shows the particles of Pinnacle® and Authority® had similar length distributions, which is desirable for producing homogenous mixtures of particles.

Weight percentages were calculated based on volume percentages and envelope densities. As the envelope densities of the light-colored and dark-colored particles are 1.85 and 1.43 g/cm³, respectively, Formula 5 gives the weight percentage of light-colored particles WP^{L} in a sample containing VP^{L} volume percent of light-colored particles and VP^{D} volume percent of dark-colored particles.
WP^{L}=100% ·(1.85·VP^{L})/(1.85·VP^{L}+1.43·VP^{D}) Formula 5

Summary data for all 10 samples is listed in Table 2.

TABLE 2
Summary Data for the Samples of Pinnacle ® and Authority ® Mixtures

| | B | C | D | E | F | G | H | I |
|---|---|---|---|---|---|---|---|---|
| A | Sample | Particles | Light-colored (Pinnacle ®) | | | Dark-colored (Authority ®) | | |
| Sample | Wt. (g) | Counted | Volume % | Wt. % | (g) | Volume % | Wt. % | (g) |
| 1 | 17.31 | 3385 | 43.57 | 49.97 | 8.65 | 56.43 | 50.03 | 8.66 |
| 2 | 25.22 | 4797 | 35.24 | 41.31 | 10.42 | 64.76 | 58.69 | 14.80 |
| 3 | 27.60 | 5004 | 46.10 | 52.53 | 14.50 | 53.90 | 47.47 | 13.10 |
| 4 | 26.79 | 6179 | 40.77 | 47.10 | 12.62 | 59.23 | 52.90 | 14.17 |
| 5 | 26.80 | 6066 | 42.22 | 48.59 | 13.02 | 57.78 | 51.41 | 13.78 |
| 6 | 26.10 | 5301 | 45.27 | 51.69 | 13.49 | 54.73 | 48.31 | 12.61 |
| 7 | 27.00 | 4588 | 43.91 | 50.32 | 13.59 | 56.09 | 49.68 | 13.41 |
| 8 | 25.78 | 3793 | 43.16 | 49.55 | 12.78 | 56.84 | 50.45 | 13.00 |
| 9 | 25.54 | 5183 | 47.45 | 53.88 | 13.76 | 52.55 | 46.12 | 11.78 |
| 10 | 24.56 | 4853 | 48.39 | 54.81 | 13.46 | 51.61 | 45.19 | 11.10 |
| SUM | 252.70 | | | | 126.28 | | | 126.42 |

The bottoms of columns F and I of Table 2 sum the weights of light and dark particles calculated to be in all the samples; these sums are essentially identical with the initially weighed quantities of the separate components. This result shows the remarkable potential of this analytical method, using which Applicants were able to deconstruct the composition of the intimately mixed particle mixture back into its original components.

### EXAMPLE 3

### Analysis of Particle Mixture Samples Spanning a Known Composition Range

Seven particle mixture samples, each approximately 20 g, were prepared by mixing measured weights of light-colored Classic® 25DF Herbicide paste-extruded particles (DuPont) containing 25 wt % chlorimuron-ethyl as active ingredient (a.i.) with measured weights of dark-colored Authority® 75DF Herbicide paste-extruded particles (FMC Corp.) containing 75 wt % sulfentrazone as active ingredient, as shown in Table 3. Columns B and C list the amounts of each particle type. Columns D and F show the corresponding percentages of each particle type in the samples, and columns E and G show the calculated percentages of active ingredients chlorimuron-ethyl (CE) and sulfentrazone in the samples based on their known compositions.

TABLE 3
Composition of Prepared Mixture Samples

| | B | C | | | F | G |
|---|---|---|---|---|---|---|
| | Actual Samples | | D | E | Authority ® 75DF | |
| A | Classic ® | Authority ® | Classic ® 25DF | | | Sulfentrazone |
| Sample No. | 25DF (g) | 75DF (g) | Formulation | CE a.i. | Formulation | a.i. |
| 1 | 6.43 | 13.65 | 32.0% | 8.0% | 68.0% | 51.0% |
| 2 | 6.82 | 13.21 | 34.0% | 8.5% | 66.0% | 49.5% |
| 3 | 7.22 | 12.80 | 36.0% | 9.0% | 64.0% | 48.0% |
| 4 | 7.53 | 12.51 | 37.6% | 9.4% | 62.4% | 46.8% |
| 5 | 8.00 | 12.03 | 40.0% | 10.0% | 60.0% | 45.0% |
| 6 | 8.41 | 11.62 | 42.0% | 10.5% | 58.0% | 43.5% |
| 7 | 8.81 | 11.20 | 44.0% | 11.0% | 56.0% | 42.0% |

The samples were each analyzed using the method of the present invention. Samples were passed through the present apparatus more than once to ensure that 4000 particles were imaged. The data was treated in the same way as described in Example 2 above. An estimate was then made for the percentage of each active ingredient in each sample, based on the volume percentage of each type of particle, their measured envelope densities, and the percentage active ingredient known to be in each. The results are shown in Table 4.

TABLE 4
Analysis of Samples Prepared from Mixtures of Classic ® and Authority ®

| | A | B | C | D | E | F | G | H |
|---|---|---|---|---|---|---|---|---|
| | Classic ® 25DF | | Chlorimuron-ethyl A.I. | | Authority ® 75DF | | Sulfentrazone A.I. | |
| Sample | Volume % | Wt % | Meas. Wt % | Input Wt % | Volume % | Wt % | Meas. Wt % | Input A.I. |
| 1 | 32.6 | 31.2 | 7.8 | 8.0 | 67.3 | 68.8 | 51.6 | 51.0 |
| 2 | 33.8 | 32.3 | 8.1 | 8.5 | 66.3 | 67.7 | 50.8 | 49.5 |
| 3 | 36.5 | 35.0 | 8.7 | 9.0 | 63.5 | 65.0 | 48.8 | 48.0 |
| 4 | 37.6 | 36.0 | 9.0 | 9.4 | 62.4 | 64.0 | 48.0 | 46.8 |
| 5 | 39.7 | 38.1 | 9.5 | 10.0 | 60.3 | 61.9 | 46.4 | 45.0 |
| 6 | 42.0 | 40.4 | 10.1 | 10.5 | 57.9 | 59.6 | 44.7 | 43.5 |
| 7 | 44.0 | 42.4 | 10.6 | 11.0 | 55.9 | 57.6 | 43.2 | 42.0 |

Columns A and E list the volume percentages of Classic® 25DF and Authority® 75DF particles determined by the method of the present invention to be in each mixed sample. Columns B and F list the weight percentages of these formulations calculated based on envelope densities of 1.43 g/cm³ for Classic® 25DF and 1.53 g/cm³ for Authority® 75DF. Columns C and G list the measured weight percentages (Meas. Wt %) of chlorimuron-ethyl active ingredient and sulfentrazone active ingredient, respectively, calculated from the weight percentages calculated for the formulations and the known concentration of active ingredients in each particle type. These measured values were compared to the input weight percentages (Input Wt %) calculated on the basis of the weights of Classic® 25DF and Authority® 75DF used to prepare the samples, as shown in columns D and H. Comparison between columns C and D and between columns G and H showed that the measured weight percentages of chlorimuron-ethyl are close but consistently slightly lower and the measured weight percentages of sulfentrazone are close but consistently slightly higher than the corresponding values calculated from the weights of Classic® 25DF and Authority® 75DF used to prepare the samples.

### EXAMPLE 4

### Analysis of a Mixture of Seven Differently Colored Particle Types

A package of colored, coated candies was purchased. The sample of 51 candies was well mixed and contained uniform particles of round oval shape (similar to that depicted in FIG. 6E) approximately 12 mm in diameter and approximately 5 mm thick at the point of greatest thickness. Each particle had a distinct color. Seven different colors were present in the mixture. In this example, the distribution of particles according to color was analyzed by the method of the present invention. The present apparatus as described in Example 1 was employed except that instead of a black and white camera, a color Sony DFW-X700 Digital Video Camera was used as image receiver 6 (in FIG. 1). The sample was fed to inclined surface 4 (FIG. 1) of the apparatus, and when all 51 particles in the sample had passed down inclined surface 4, the same sample was fed again. This was repeated several times until 41 particle images were collected. These images of the particles were digitized and the information from each pixel was simultaneously fed into two separate electronic buffers configured differently for storing the color camera output. The first buffer was configured to store the total intensity of light on each pixel so that the black background of the inclined surface could be differentiated from the profiles of the falling particles, allowing the area in pixels for each particle image to be determined. In addition, this data was evaluated to determine particle image perimeters, from which particle diameters were directly calculated. The second buffer was configured to store the intensities of light at red, green and blue wavelengths. Each of the 25 pixels surrounding the centroid of each particle image was then evaluated for its intensity (excitation level) on a scale of from 0 to 255 units of red (R), green (G) and blue (B) light, and then average red, green and blue intensities were calculated for the 25-pixel area on each particle. Particles representative of each of the seven distinct color particle types were chosen to define color standard calibration values. The representative particles were held stationary while color measurements were made. The results are listed in Table 5.

TABLE 5
Calibration Values for Color Standards

| Color | Average Intensities | | |
|---|---|---|---|
| Standard | Red Light | Green Light | Blue Light |
| Yellow | 255 | 255 | 129 |
| Red | 255 | 111 | 14 |
| Purple | 212 | 181 | 211 |
| Green | 203 | 255 | 148 |
| Brown | 151 | 82 | 30 |
| Blue | 83 | 183 | 217 |
| Aqua | 198 | 255 | 239 |

An example of the algorithm used to determine the color of each pixel in a particle image is shown in Formula 6 for the yellow standard.
|Rₘₑₐₛ−R_{cal(y)}|+|Gₘₑₐₛ−G_{cal(y)}|+|Bₘₑₐₛ−B_{cal(y)}|=Yellow Color Match Deviation Formula 6
In Formula 6, Rₘₑₐₛ, Gₘₑₐₛ and Bₘₑₐₛ are the red, green and blue light intensities measured for each particle. Replacing the yellow color calibration values R_{cal(y)}, G_{cal(y)} and B_{cal(y)} with the red, green and blue intensity values listed in Table 5 for the yellow standard gives Formula 6a.
|Rₘₑₐₛ−255|+|Gₘₑₐₛ−255|+|Bₘₑₐₛ−129|=Yellow Color Match Deviation Formula 6a
In Formulae 6 and 6a, Yellow Color Match Deviation is the sum of the absolute deviations between the measured red, green and blue intensities and the corresponding intensities calibrated for the yellow color standard.

For each particle image the process is repeated for all 7 colors using formulae analogous to Formulae 6 and 6a. If, for example, a particle is yellow, then the measured excitation values should approximate those of the yellow standard listed in Table 5, and the sum of the absolute values of the differences shown in Formulae 6 and 6a should be small—in fact, near zero. When the excitation levels for the other color standards are substituted, then the Color Match Deviations calculated should be larger than the Yellow Color Match Deviation.

Table 6 shows the Color Match Deviations calculated from Formulae 6 and 6a and their analogs for each of 41 particle images captured. The data is grouped according to the most likely color of the particle, shown in the last column, based on the smallest Color Match Deviation value, each of which is bolded.

TABLE 6
Assessment of Color for Each Particle Image Measured

| Color Match Deviations | | | | | | | Best |
|---|---|---|---|---|---|---|---|
| Yellow | Red | Purple | Green | Brown | Blue | Aqua | Color Match |
| 4 | 262 | 196 | 68 | 380 | 329 | 163 | Yellow |
| 8 | 251 | 207 | 79 | 368 | 341 | 175 | Yellow |
| 8 | 250 | 208 | 80 | 368 | 341 | 175 | Yellow |
| 11 | 248 | 207 | 83 | 365 | 341 | 178 | Yellow |
| 11 | 270 | 188 | 60 | 387 | 322 | 156 | Yellow |
| 15 | 274 | 185 | 57 | 391 | 318 | 152 | Yellow |
| 17 | 242 | 216 | 88 | 359 | 350 | 184 | Yellow |
| 23 | 236 | 221 | 94 | 354 | 354 | 190 | Yellow |
| 25 | 283 | 175 | 57 | 401 | 308 | 142 | Yellow |
| 27 | 232 | 188 | 98 | 349 | 322 | 194 | Yellow |
| 53 | 205 | 191 | 125 | 323 | 325 | 220 | Yellow |
| 75 | 334 | 132 | 14 | 358 | 257 | 92 | Green |
| 126 | 384 | 161 | 158 | 502 | 282 | 72 | Aqua |
| 164 | 95 | 214 | 235 | 213 | 352 | 331 | Red |
| 169 | 90 | 219 | 240 | 207 | 358 | 336 | Red |
| 170 | 89 | 220 | 241 | 206 | 359 | 337 | Red |
| 170 | 89 | 221 | 242 | 206 | 359 | 337 | Red |
| 180 | 79 | 231 | 252 | 196 | 369 | 347 | Red |
| 217 | 42 | 267 | 288 | 159 | 406 | 384 | Red |
| 228 | 30 | 279 | 300 | 148 | 417 | 395 | Red |
| 245 | 40 | 295 | 316 | 132 | 433 | 412 | Red |
| 251 | 25 | 302 | 323 | 125 | 440 | 419 | Red |
| 266 | 19 | 317 | 338 | 129 | 455 | 434 | Red |
| 284 | 25 | 334 | 355 | 152 | 473 | 451 | Red |
| 310 | 61 | 346 | 367 | 128 | 485 | 463 | Red |
| 314 | 55 | 359 | 380 | 141 | 498 | 476 | Red |
| 347 | 108 | 333 | 353 | 114 | 471 | 449 | Red |
| 172 | 326 | 42 | 143 | 383 | 163 | 99 | Purple |
| 173 | 318 | 27 | 122 | 353 | 160 | 108 | Purple |
| 176 | 321 | 31 | 142 | 372 | 157 | 105 | Purple |
| 177 | 330 | 38 | 141 | 379 | 159 | 96 | Purple |
| 119 | 261 | 80 | 151 | 378 | 214 | 165 | Purple |
| 189 | 315 | 11 | 136 | 348 | 144 | 111 | Purple |
| 211 | 280 | 45 | 141 | 296 | 167 | 145 | Purple |
| 220 | 169 | 185 | 188 | 156 | 278 | 273 | Brown |
| 291 | 144 | 256 | 259 | 85 | 304 | 345 | Brown |
| 261 | 238 | 182 | 190 | 159 | 209 | 270 | Brown |
| 379 | 139 | 344 | 354 | 114 | 471 | 449 | Brown |
| 504 | 258 | 469 | 472 | 128 | 348 | 557 | Brown |
| 319 | 410 | 120 | 248 | 320 | 42 | 190 | Blue |
| 322 | 411 | 122 | 250 | 320 | 42 | 193 | Blue |

With only 41 particle images collected from the sample of 51 particles, some statistical error from sampling is to be expected. For comparison, the actual particle color distribution and that measured using the method and apparatus of the present invention are shown in Table 7.

TABLE 7
Comparison of Measured versus Counted Color Distributions

| A | B | C | D | E |
|---|---|---|---|---|
| Color | Actual Count | % Count | Measured | % Measured |
| Yellow | 14 | 27.5 | 11 | 26.8 |
| Red | 14 | 27.5 | 14 | 34.1 |
| Purple | 10 | 19.6 | 7 | 17.1 |
| Green | 2 | 3.9 | 1 | 2.4 |
| Brown | 6 | 11.8 | 5 | 12.2 |
| Blue | 4 | 7.8 | 2 | 4.9 |
| Aqua | 1 | 2.0 | 1 | 2.4 |
| Total | 51 | 100 | 41 | 100 |

Columns B and D in Table 7 show the actual number for each color in the original sample versus the measured number. Columns C and E provide a more direct comparison based on the percentages of particles of each color in the sample versus the measured values. Considering the small number of particles in the sample analyzed, the comparison is remarkably close.

Determination of the diameter of the particles based on the particle images gave an average of 11.7 mm compared to 12.7-14 mm from direct measurement using calipers. This was again in good agreement considering the preliminary nature of the experiment.

### EXAMPLE 5

### Analysis of a Particle Mixture in which One Particle Type is Given a Distinguishing Color

In many cases different particle types are similar in grayscale values when viewed under visible light and thus cannot be differentiated using a black and white video camera such as was used in Examples 2 and 3 above. To provide differing spectral characteristics a dye can be incorporated into the composition of one of the particle types. In this example, about 1% by weight of FD&C Blue Dye #1 (CAS No: 2650-18-2) is included in a kaolin clay-based paste-extruded particle formulation. The resulting particle becomes blue in color and reflects light at 450-500 nm. In another kaolin clay-based paste-extruded particle formulation, no dye is added so the particles remain light tan in color.

The present apparatus as described in Example 1 is used except that image receiver 6 (in FIG. 1) is a color video camera. A 40-g sample is prepared by mixing thoroughly 20 g of tan-colored particles and 20 g of blue-colored particles. Each particle type is cylindrically shaped with approximately a 1 mm diameter, and particle lengths range from 1 to 4 mm. The mixture of light tan and blue particles is analyzed by the method of the present invention. The images are digitized and the information from each pixel is fed into two separate buffers configured differently for storing the color camera output. The first buffer is configured to store the total intensity of light on each pixel so that the black background of the inclined surface is differentiated from the profiles of the falling particles, allowing the area in pixels for each particle image to be determined. In addition, this data is evaluated to calculate particle width, length and volume according to the method described in Example 2. The second buffer is configured to simultaneously store the intensities of light at red, green and blue wavelengths. Each of the 25 pixels surrounding the centroid of each particle image is then evaluated for the intensity of blue light received and an average calculated for each particle. This information is used to identify the imaged particles as belonging to “Blue” or “Not Blue” particle types using the general method described in Example 4. Then using the calculated particle volumes and measured envelope densities, the volume percentage and weight percentage of each particle type in the mixture is calculated using the general method described in Example 2.

### EXAMPLE 6

### Analysis of a Particle Mixture in which Particle Types are Distinguished Using UV Light

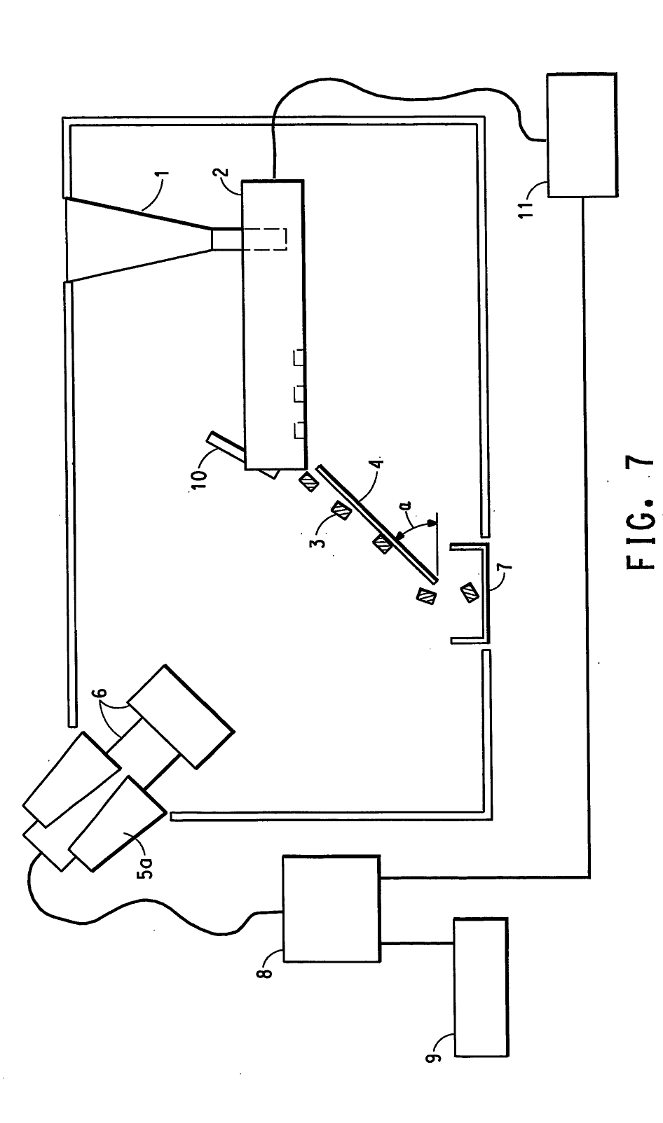

When particle formulations contain dark-colored ingredients, such as ligninsulfonate surfactants, adding a colored ingredient to one formulation may not make it sufficiently distinguishable from the other on the basis of optical properties. If two dark-colored particle types are mixed together, another way to differentiate the particle types is to formulate them with different levels of an ingredient fluorescent under ultraviolet light such as fluorescein. In this example, a kaolin-based, paste-extruded particle containing ligninsulfonate is formulated to contain 0.5% by weight of fluorescein. Another kaolin-based paste-extruded particle containing ligninsulfonate is formulated to contain 1% by weight of fluorescein. As ambient visible light is best excluded during imaging using fluorescence, the present apparatus as described in Example 1 with reference to FIG. 1 is modified as depicted in FIG. 7. The components of the apparatus shown in FIG. 7 are as described in Example 1 for FIG. 1 with differences noted as follows. Chamber 12 surrounds components of the apparatus including inclined surface 4 and image receiver 6 to shield them from ambient visible light. Openings in chamber 12 allow introduction of particles 3 to be evaluated into hopper 1, enable removal of the analyzed sample with catch tray 7, and to enable illumination source 5a to irradiate falling particles 3 and image receiver 6 to record images of falling particles 3. Illumination source 5a comprises a source of ultraviolet light, such as a mercury-vapor electric discharge lamp. Image receiver 6 comprises a black and white camera.

Fluorescein emits orange-colored light when irradiated with ultraviolet light. The fluorescein content in each particle type is at different levels, providing differing levels of luminescence, which is captured by the black and white camera. Particle images showing higher levels of luminescence correspond to the particles containing 1% by weight of fluorescein, and particle images showing lower levels of luminescence correspond to the particles containing 0.5% by weight of fluorescein. The data collected for the sample can then be analyzed according to the general methods described in Example 2.

### EXAMPLE 7

### Quality Analysis of Rice Product Using Visible Light

Rice food products may contain processed rice grains from different sources. These combinations generate a pleasing blend of flavors and aromas for the customer. In this example a rice product is produced which contains two processed rice types: a white-colored long grain rice and a dark-colored wild rice variety. The product is a mixture of the two types and the composition is targeted for the ratio of 75 percent by weight of white rice and 25 percent by weight of wild rice. A quality assurance system is devised involving randomly pulling packages of rice product from the production line and analyzing the ratio of white to wild rice using the present invention. The envelope densities of the two rice types are measured and found to be essentially the same. Each 8-ounce (227 g) sample is evaluated in its entirety using the general method described in Example 2. For analysis of this type of product ±10% relative precision is sufficient. Therefore it is acceptable to treat the shape of the rice grains as cylindrical, although it would be simple to use an alternate algorithm which considers the grains to be ellipsoidal in shape. The entire contents of the product package are fed through the apparatus described in Example 1 for FIG. 1. Following the general method described in Example 2, the volume of each grain imaged is calculated from the corresponding particle image. Each image is also evaluated to identify the corresponding grain as a member of the white rice or wild rice type, allowing calculation of the volume percentages of each type. As the envelope densities for the two rice types are equal, the weight percentages are identical to the volume percentages for both components.

### EXAMPLE 8

### Analysis of the Mixture of Particles Having Two Different Shapes

This Example shows how a mixture of cylindrical and ellipsoidal particles can be analytically separated using the method of this invention.

Three samples were prepared by mixing cylindrical particles made using a paste extrusion process with roughly ellipsoidal particles made using a pan granulation process. Three mixtures were prepared as shown in Table 8.

TABLE 8
Mixture Preparation

| | Cylindrical | | Ellipsoidal | |
|---|---|---|---|---|
| Sample | Amount (g) | Weight fraction | Amount (g) | Weight fraction |
| 1 | 6.00 | 0.741 | 2.10 | 0.259 |
| 2 | 3.90 | 0.506 | 3.80 | 0.494 |
| 3 | 2.80 | 0.318 | 6.00 | 0.682 |

The paste-extruded particles were cylinders approximately 1 mm in diameter with lengths ranging from 0.5 mm to 5 mm. The pan-granulated particles were shaped like roughly ellipsoidal pellets with lengths generally not much more that 50% greater than widths. Variation in their ellipsoidal particle size generally involved proportionate extension of both length and width.

The samples were analyzed using the present apparatus as described in Example 1. Each sample was passed through the apparatus repeatedly to accumulate data so that 912, 472 and 551 individual particle images were obtained for samples 1, 2, and 3, respectively. The data was analyzed with the intention of separating particle images and their dimensional parameters into cylindrical and ellipsoidal particle groups.

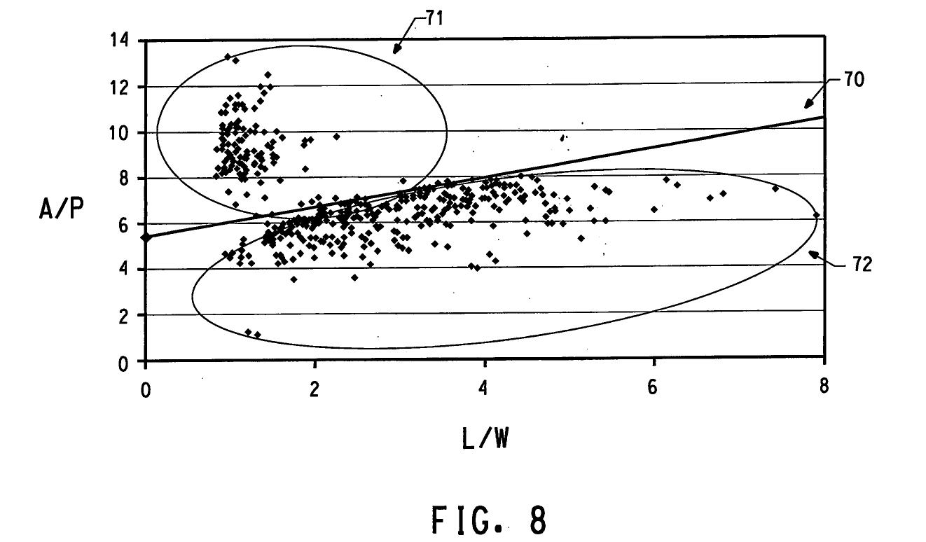

Particle lengths, widths, perimeters and areas were determined using LabView IMAQ software and the general methods described in Example 2. The area/perimeter ratio (A/P) was plotted against the length/width ratio (L/W) for each particle image as illustrated in FIG. 8. Based on the visually apparent clustering of data points, slanted line 70 (with a slope of 0.6417 and y-axis intercept of 5.3) was drawn to separate the clusters of ellipsoidal particle data points 71 and cylindrical particle data points 72. This process enabled the data sets for the three samples to each be divided into two subsets with the ellipsoidal data in one subset and the cylindrical data in the other. This analysis of particle images indicated 817 likely cylindrical particles and 95 likely ellipsoidal particles for sample 1, 329 likely cylindrical particles and 143 likely ellipsoidal particles for sample 2, and 337 likely cylindrical particles and 214 likely ellipsoidal particles for sample 3.

To determine the weight percentages of each particle type in the mixtures, the total volumes of the particles of each type was first calculated. To calculate lengths of particles needed to calculate the L/W ratios plotted in FIG. 8, the particle image areas were simply divided by particle image lengths. For calculation of volumes of cylindrical particles, which give rectangular images, this method for calculating length is reasonably accurate. However, for calculation of volumes of ellipsoidal particles, which give elliptical images, the more accurate method described by Formula 7, wherein Lₑ is the length, A is the image area and W is the image width, was used to determine length.
Lₑ=(4·A)/(π·W) Formula 7

The individual volumes for each particle were then calculated. For cylindrical particles the volumes were calculated according to Formula 8 wherein V_{c} is volume, W is image width and L_{c} is length.
V_{c}=·(W/2)²·L_{c} Formula 8

For ellipsoidal particles volumes were calculated according to Formula 9 wherein Vₑ is volume, W is image width and Lₑ is length.
Vₑ=( 4/3)·π·(W/2)²·(Lₑ/2) Formula 9

The volumes of cylindrical and ellipsoidal particles were separately summed, and then the volume fraction of each particle type was calculated. Total weights for each particle type were calculated by multiplying the total volumes by the envelope densities, which were 1.33 g/cm³ for the paste-extruded cylinders and 1.21 g/cm³ for the pan-granulated ellipsoids. The total weights were used to calculate the weight fractions of each particle type in each of the samples. Table 9 lists the weight fractions measured according to this invention along with the actual weight fractions for comparison.

TABLE 9
Comparisons of Actual versus Measured Weight Fractions

| | Cylindrical | | Ellipsoidal | | |
|---|---|---|---|---|---|
| | Actual | | Actual | | |
| | Mixed | Measured | Mixed | Measured | |
| | Weight | Weight | Weight | Weight | |
| Sample | Fraction | Fraction | Fraction | Fraction | Data Points |
| 1 | 0.741 | 0.767 | 0.259 | 0.233 | 912 |
| 2 | 0.506 | 0.443 | 0.494 | 0.557 | 472 |
| 3 | 0.318 | 0.287 | 0.682 | 0.713 | 551 |

The results show the results from the method and apparatus of the present invention remarkably closely approximate the actual sample compositions considering the small sample size and empirical method used to differentiate cylindrical and ellipsoidal particles. Sample 1, which had the largest sample size and thus smallest statistical sampling error, yielded the most accurate results. Besides the statistical sampling error, some error likely came from the inability to completely accurately distinguish images of cylindrical particles from ellipsoidal particles using the A/P versus L/P cluster method, particularly for particles having A/P and LIP ratios in the region where the clusters meet. Other image analysis approaches such as distinguishing rectangular outlines from elliptical outlines in particle images may more accurately identify particle types. Nevertheless, the results from this Example amply illustrate the considerable value of the methods of this invention for determining particle mixture composition where the differentiating feature is particle shape.

What is claimed is:

1. A method for determining the proportion of differing particle types in a mixture, comprising:
(i) feeding a mixture comprising at least two particle types of non-cohesive particles, each particle type having at least one optical property and/or shape differing from another particle type, to a path inclined at an angle sufficient to enable the particles to descend along the path;
(ii) illuminating the particles along the inclined path;
(iii) collecting reflective-light images of the illuminated particles; and
(iv) calculating the proportion of at least one particle type based on data from the reflective light images indicative of the at least one differing optical property and/or shape.

2. The method of claim 1, wherein the at least one optical property is at least one of reflectance, luminescence and variations thereof at visible, ultraviolet and infrared wavelengths.

3. The method of claim 2 further comprising calculating at least one dimensional property.

4. The method of claim 3, wherein the at least one dimensional property is at least one of longest dimension, shortest dimension, area and perimeter.

5. The method of claim 1, wherein the inclined path is about 60° or less from horizontal.

6. The method of claim 1, wherein the reflective-light images are collected at about perpendicular to the inclined path.

7. The method of claim 1, wherein the feeding comprises disposing the particles near an exit end of a feeder from which the particles are fed to the inclined path, and wherein the inclined path comprises an inlet end located adjacent to and below the feeding exit end.

8. The method of claim 1, wherein less than 25% of the particles on the inclined path are touching another particle in the reflective-light images.

9. The method of claim 8, wherein less than 10% of the particles on the inclined path are touching another particle in the reflective-light images.

10. The method of claim 9, wherein less than 2% of the particles on the inclined path are touching another particle in the reflective-light images.

11. The method of claim 3, wherein the non-cohesive particles are non-spheroidal and at least 80% of the particles have a bounce angle of 10 degrees or less.

12. The method of claim 11, wherein at least 90% of the particles have a bounce angle of 10 degrees or less.

13. The method of claim 11, wherein at least 95% of the particles have a bounce angle of 10 degrees or less.

14. The method of claim 11, wherein the feeding comprises disposing the particles near an exit end of a feeder from which the particles are fed to the inclined path, and wherein the inclined path comprises an inlet end located adjacent to and below the feeding exit end so as to define a gap between the exit end and the inlet end.

15. The method of claim 14, wherein the gap has a length which is equal to or less than the shortest dimension of the particles [to be measured].

16. The method of claim 1, wherein the mixture of non-cohesive particles comprises particles substantially cylindrical in shape.

17. The method of claim 1, wherein the mixture of non-cohesive particles comprises particles having a shape substantially cylindrical with a circular cross-section.

18. The method of claim 1, wherein the mixture of non-cohesive particles comprises seed.

19. The method of claim 1, wherein the mixture of non-cohesive particles comprises particles comprising at least one agriculturally active material.

20. The method of claim 1, wherein the mixture of non-cohesive particles comprises particles comprising at least one crop protection agent.

21. The method of claim 1, wherein inert gas is blown across a surface of the inclined path.

22. An apparatus for determining the proportion of particles of differing particle types in a mixture comprising:
(i) a particle feeder having an exit end;
(ii) an inclined path having an upper inlet end located adjacent to and below the exit end of the feeder to enable descent of non-cohesive particles down the inclined path;
(iii) a source of illumination oriented with respect to the inclined path so as to enable top-illumination of the particles as they descend down the inclined path;
(iv) an image receiver oriented with respect to the inclined path so as to enable collection of reflective-light images of the particles as they descend down the inclined path; and
(v) a composition calculator which converts reflective-light image signals received from the image receiver into data indicative of at least one proportion of particle types in the mixture based on at least one optical property and/or shape of the particles.

23. The apparatus of claim 22 wherein the image receiver comprises a color camera.
